(19) United States
(12) Patent Application Publication
(10) Pub. No.: US 2026/0044754 A1
(43) Pub. Date: Feb. 12, 2026

(54) IDENTITY-BASED CONTEXT GENERATION FOR LANGUAGE MODELS USING SECURITY GROUP ASSIGNMENTS

(71) Applicant: Dell Products L.P., Round Rock, TX (US)

(72) Inventors: Nicholas E. Reith, Round Rock, TX (US); Sujan Aryal, Pflugerville, TX (US); Danilo Peixoto Ferreira, Rio de Janeiro (BR); Sunday Kathleen Patterson, Austin, TX (US); Chandra Sekhar Uppuluri, Austin, TX (US); Bruno Magistrali Kremer, Porto Alegre (BR); Vicente Coelho Lobo Neto, Campinas (BR); Fernando Ottavio Leal Prates, Porto Alegre (BR)

(21) Appl. No.: 18/797,659

(22) Filed: Aug. 8, 2024

(51) Int. Cl. G06N 5/04; H04L 9/40

(52) U.S. Cl. CPC G06N 5/04; H04L 63/104

(57) ABSTRACT

Techniques are provided for identity-based context generation for language models using security group assignments. One method comprises obtaining a user query; obtaining information characterizing an assignment, based on an identity-based authentication of the user, of the user to a security group; providing the user query to an information retrieval system that generates query results using embedded data sources accessible by the security group of the user; providing the user query with at least a portion of the query results as context to a language model, associated with a chat assistant, to obtain a response, wherein the response is based on one or more of the query results; and providing the response to a user. A platform may be provided that allows chat assistants and/or embedded data sources to be shared with other users.

### BACKGROUND

A chat assistant (sometimes referred to as a chatbot) is a computer-generated agent that answers user questions through an online chat platform. Users increasingly engage with chat assistants in various environments, such as retail environments and customer support environments, and for various purposes. There are a number of challenges, however, that need to be addressed in order for such chat assistants to be successfully generated and deployed by organizations.

### SUMMARY

Illustrative embodiments of the disclosure provide techniques for identity-based context generation for language models using security group assignments. One method includes obtaining at least one query, for at least one processor-based chat assistant, from at least one user; obtaining information characterizing an assignment, based at least in part on an identity-based authentication of the at least one user, of the at least one user to at least one security group; providing the at least one query to an information retrieval system that generates one or more query results using one or more embedded data sources accessible by the at least one security group of the at least one user; providing the at least one query with at least a portion of the one or more query results as context to at least one language model, associated with the at least one processor-based chat assistant, to obtain a response, wherein the response is based at least in part on one or more of the query results; and providing the response to the at least one user

Illustrative embodiments can provide significant advantages relative to conventional techniques. For example, technical problems related to such conventional techniques are mitigated in one or more embodiments by limiting a response of a chat assistant to a given user to information obtained from data sources that are accessible by the security group associated with the given user.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for identity-based context generation for language models using security group assignments in accordance with an illustrative embodiment;

FIG. 2 illustrates a user registration process that creates a user record in one or more enterprise databases in accordance with an illustrative embodiment;

FIG. 3 illustrates an exemplary implementation of a process for identity-based context generation for language models using security group assignments in accordance with an illustrative embodiment;

FIG. 4 illustrates a generation of a response for a chat assistant based at least in part on an augmented user query applied to a language model in accordance with an illustrative embodiment;

FIG. 5 illustrates a processing of a conversational dialog between a user and a chat assistant using identity-based context generation for language models based on security group assignments in accordance with an illustrative embodiment;

FIG. 6 is a sample table illustrating exemplary information maintained for representative embedded data sources in accordance with an illustrative environment;

FIG. 7 is a sample table illustrating exemplary information maintained for representative chat assistants that are shared in accordance with an illustrative environment;

FIG. 8 is a flow diagram illustrating an exemplary implementation of a process for identity-based context generation for language models using security group assignments in accordance with an illustrative embodiment;

FIG. 9 illustrates an exemplary processing platform that may be used to implement at least a portion of one or more embodiments of the disclosure comprising a cloud infrastructure; and

FIG. 10 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for identity-based context generation for language models using security group assignments.

One or more aspects of the disclosure recognize that generative artificial intelligence (AI) and various large language models (LLMs) frameworks have led to uncoordinated efforts to build Generative AI chat applications for large organizations, such as enterprises. In many organizations, multiple teams have generated standalone LLM frameworks, resulting in an inefficient distribution of organization resources as multiple alternatives are proposed to solve the same problems differently. In addition, many proposed LLM frameworks lack important enterprise features such as security, automation and/or compliance (creating significant risks for large organizations). Further, the generation of such LLM frameworks typically requires significant knowledge of multiple aspects of software engineering, such as full-stack development, best practices for code design, security, continuous integration and continuous delivery (CI/CD), compliance-aware development and containerization (e.g., using Kubernetes orchestration system). Also, since the generation of such LLM frameworks is not coordinated or standardized, it is often difficult to share, collaborate and compare results to find the best solutions. A need therefore exists for a mature, enterprise-ready generative AI chat platform that meets the needs of many users, such as coders and non-coders, through customization and shared experiments that can help to solve enterprise problems.

In one or more embodiments, techniques are provided for identity-based context generation for language models using security group assignments.

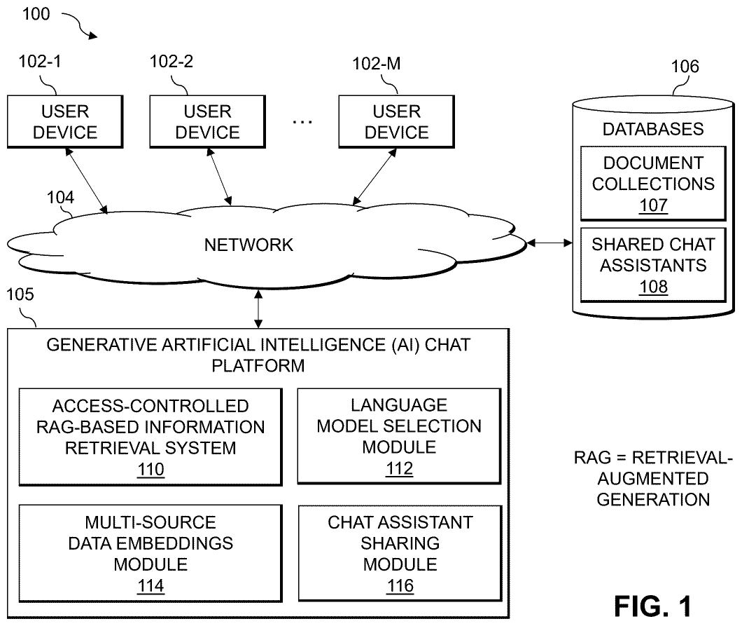

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a generative AI chat platform 105.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

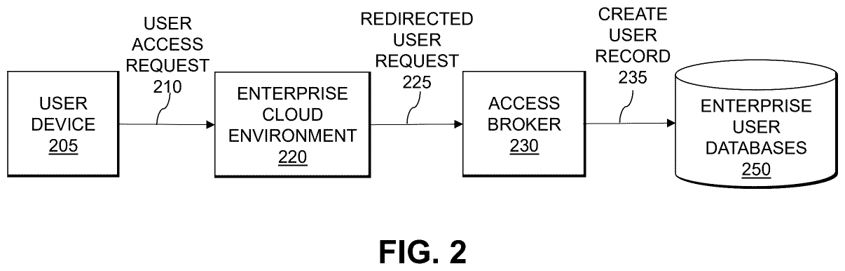

The generative AI chat platform 105 comprises an access-controlled RAG (retrieval-augmented generation)-based information retrieval system 110, a language model selection module 112, a multi-source data embeddings module 114 and a chat assistant sharing module 116. RAG is a technique for enhancing the accuracy and/or reliability of generative artificial intelligence models, such as a language model, with information obtained from external sources, as discussed further below. Exemplary processes utilizing elements 110, 112, 114 and/or 116 will be described in more detail with reference to, for example, the flow diagrams of FIGS. 2 through 4 and 8.

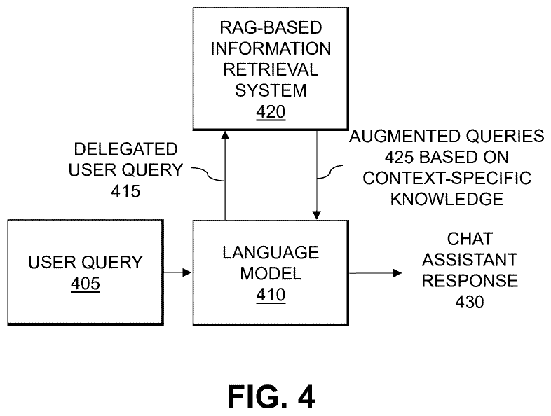

In at least some embodiments, the access-controlled RAG-based information retrieval system 110 may employ techniques to enhance the accuracy and/or reliability of generative AI models with information obtained from external sources, as discussed further below in conjunction with FIG. 4, for example. The language model selection module 112 may allow a user to select one or more language models, for example, from a library of available language models, to be used to answer one or more queries of the user. The multi-source data embeddings module 114 may generate embeddings of one or more data sources that will be used to answer one or more queries of one or more users. The chat assistant sharing module 116 may allow users to share one or more generated chat assistants with other users and allow a given user to select one or more chat assistants, for example, from a library of available chat assistants, to be used to answer one or more queries of the user.

In some embodiments, the generative AI chat platform 105 may be deployed and reused, for example, using a Helm deployment chart or another deployment package that contains the necessary resources to deploy the generative AI chat platform 105 to a container cluster. For example, the deployment package may comprise YAML configuration files for deployments, services, secrets and/or configuration maps that define the desired state of the generative AI chat platform 105.

It is to be appreciated that this particular arrangement of elements 110, 112, 114 and/or 116 illustrated in the generative AI chat platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

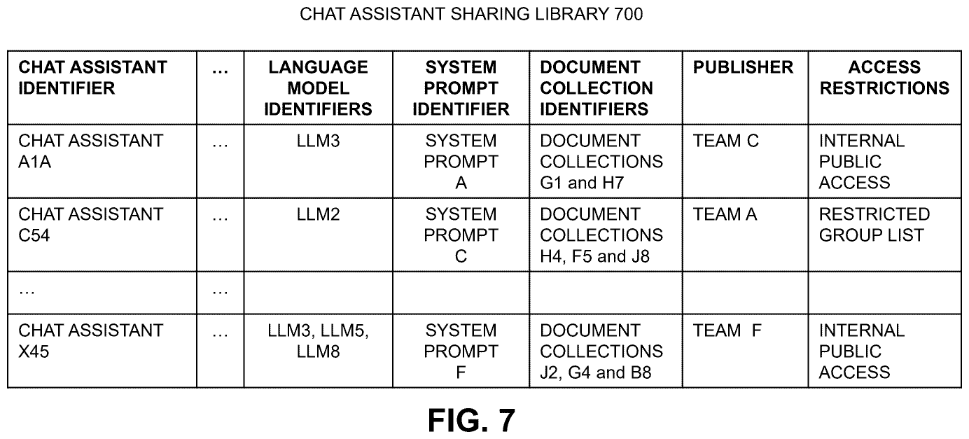

Additionally, the generative AI chat platform 105 can have at least one associated database 106 configured to store data pertaining to, for example, document collections 107 (e.g., comprising embedded data sources) and a repository of one or more shared chat assistants 108, as discussed further below in conjunction with FIG. 7. The database 106 may employ enterprise content management tools and/or knowledge management tools, such as those provided by Confluence, ServiceNow and/or SharePoint. In addition, the Airflow open-source workflow management platform may be employed in one or more embodiments for pipeline orchestration to update the embedded data sources. In some embodiments, a storage of at least some of the document collections 107 may be implemented using a vector database, such as a postgres database with a postgres vector plugin, and/or the Milvus open-source vector database system.

In one or more embodiments, the generative AI chat platform 105 may conform to one or more enterprise standards of a given organization, such as security and accessibility standards. In addition, the generative AI chat platform 105 may include mechanisms to automatically (i) update software packages and libraries, (ii) apply patches for security vulnerabilities and (iii) implement authentication and authorization for enterprise employees and other users.

An example database 106, such as depicted in the present embodiment, can be implemented using one or more storage systems associated with the generative AI chat platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the generative AI chat platform 105 are one or more input-output devices, which illustratively comprise keyboards, displays or other types of input-output devices in any combination. Such input-output devices can be used, for example, to support one or more user interfaces to the generative AI chat platform 105, as well as to support communication between generative AI chat platform 105 and other related systems and devices not explicitly shown.

Additionally, the generative AI chat platform 105 in the FIG. 1 embodiment is assumed to be implemented using at least one processing device. Each such processing device generally comprises at least one processor and an associated memory, and implements one or more functional modules for controlling certain features of the generative AI chat platform 105.

More particularly, the generative AI chat platform 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the generative AI chat platform 105 to communicate over the network 104 with the user devices 102, and illustratively comprises one or more conventional transceivers.

It is to be understood that the particular set of elements shown in FIG. 1 for the generative AI chat platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the generative AI chat platform 105 and databases 106 can be on and/or part of the same processing platform.

FIG. 2 illustrates a user registration process that creates a user record in one or more enterprise databases in accordance with an illustrative embodiment. In the example of FIG. 2, a user device 205 provides a user access request 210 (e.g., a request to access one or more enterprise resources) to an enterprise cloud environment 220. The enterprise cloud environment 220 provides a redirected user request 225 to an access broker 230. The access broker 230 may be implemented, at least in part, using the Kubernetes orchestration system.

In some embodiments, the access broker 230 creates a user record 235 in one or more enterprise user databases 250. One or more of the enterprise user databases 250 may be implemented as a vector database, as discussed above in conjunction with the databases 106 of FIG. 1. The pipeline between the enterprise user databases 250 and the underlying embedded data sources may be orchestrated, at least in part, using the Kubernetes orchestration system.

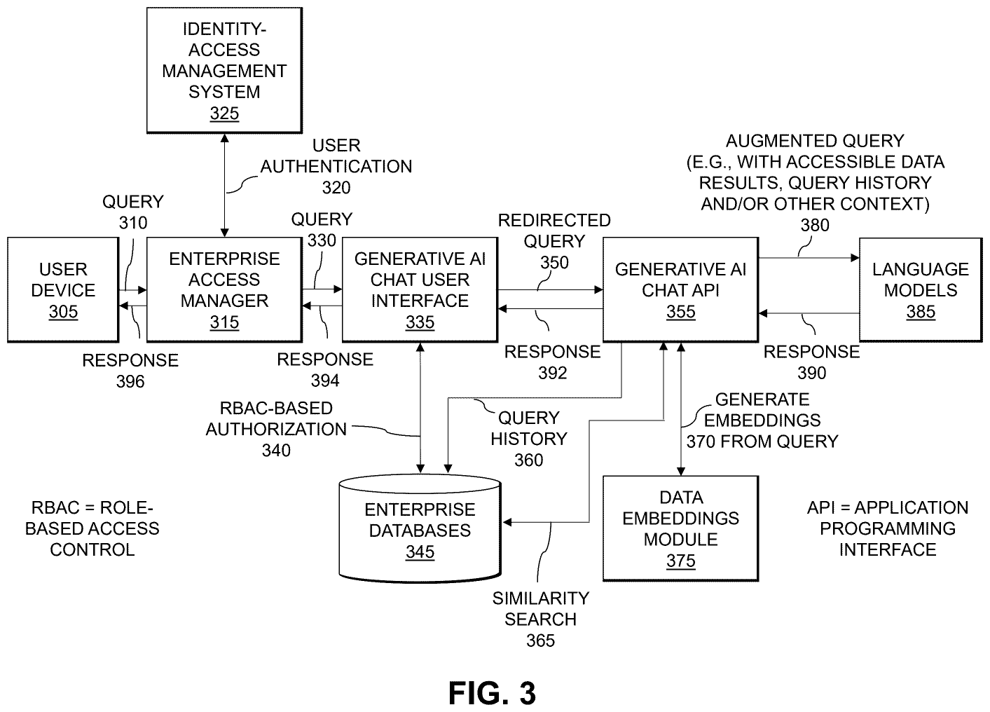

FIG. 3 illustrates an exemplary implementation of a process for identity-based context generation for language models using security group assignments in accordance with an illustrative embodiment. In the example of FIG. 3, a user device 305 provides a query 310 to an enterprise access manager 315. The query 310 may be initiated, for example, by a user of the user device 305 interacting with a browser. The enterprise access manager 315 performs a user authentication 320, of the user associated with user device 305, using an identity-access management system 325. In response to a successful authentication, in some embodiments, the identity-access management system 325 may provide a security group of the user of the user device 305 to the enterprise access manager 315. Based on the result of the user authentication 320, the enterprise access manager 315 provides query 330 to a generative AI chat user interface 335. The a user interface of the generative AI chat user interface 335 may be implemented, at least in part, using next.js.

The generative AI chat user interface 335 may perform a role-based access control (RBAC)-based authorization 340 of the user associated with the user device 305 by accessing one or more enterprise databases 345 to determine a security group assignment of the user. Generally, when a given user is assigned to a security group, the given user can access the resources and directory services common to the security group without making multiple requests.

The generative AI chat user interface 335 provides a redirected query 350 to a generative AI chat application programming interface (API) 355. The generative AI chat user interface 335 may be implemented, at least in part, using the Kubernetes orchestration system.

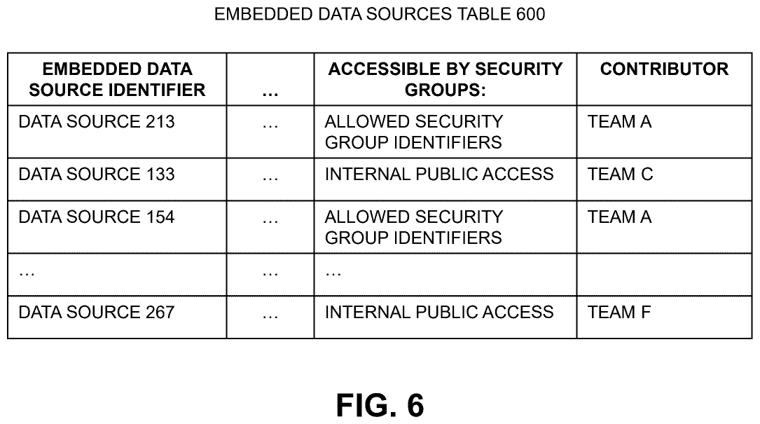

The generative AI chat API 355 obtains a query history 360, related to the redirected query 350, from the one or more enterprise databases 345. In addition, the generative AI chat API 355 performs a similarity search 365 against one or more embedded data sources stored, for example, in one or more of the enterprise databases 345. The embedded data sources are discussed further below in conjunction with FIG. 6. The generative AI chat API 355 also interacts with a data embeddings module 375 that generates one or more data embeddings 370 related to the query 330. The embeddings API may be implemented, at least in part, using the Kubernetes orchestration system, one or more Python scripts and/or a Python application, to route signals from the components interconnected with the generative AI chat API 355 via one or more APIs, such as RESTful APIs generated using the fastAPI web framework. Generally, the embedded data sources comprise vector embeddings representing tokens and/or text as dimensions of similarity.

In some embodiments, a given user may include one or more embedded data sources (e.g., personal embedded data sources) in the enterprise databases 345 to be accessed by one or more language models. The embedded data sources in the enterprise databases 345 may be associated with one or more security groups or be considered publicly accessible within the given enterprise or organization.

The generative AI chat API 355 provides an augmented query (e.g., augmented with data results accessible to the security group of the user of the user device 305, query history and/or other context, such as an overview summary based on a conversational history) 380 to one or more language models 385, such as one or more LLMs. One or more of the language models 385 may be implemented and/or deployed, at least in part, using the Kubernetes and/or LangGraph orchestration frameworks, the LangServe deployment framework and/or language model creation frameworks, such as LangChain. The one or more language models 385 may comprise one or more generative pretrained transformers (GPTs) and/or one or more open source LLMs, such as Llama 2, code Llama 2 and Zephyr. In addition, one or more of the language models 385 may be obtained from an open-source library, such as the Virtual LLM library. The Hugging Face machine learning and data science platform may be used to generate, deploy and/or train one or more of the language models 385 or models used for the embedded data sources.

The one or more language models 385 generate a response 390 that is provided to the generative AI chat API 355. The generative AI chat API 355 forwards a response 392 to the generative AI chat user interface 335, which, in turn, sends a response 394 to the enterprise access manager 315, which, in turn, sends a response 396 to the user device 305.

FIG. 4 illustrates a generation of a response for a chat assistant based at least in part on an augmented user query applied to a language model in accordance with an illustrative embodiment. In the example of FIG. 4, a user query 405 is applied to a language model 410. The user query 405 may be an explicit question asked by a user (e.g., as part of a conversational dialogue) and/or an implied question inferred from the behavior of the user. In one or more embodiments of the present disclosure, an intelligent prompt is applied to the language model 410 using a RAG-based information retrieval system 420 to benefit the conversational flow.

The language model 410 (or another backend element of the generative AI chat platform 105) may delegate the user query 405, in some embodiments, as a delegated user query 415 to the RAG-based information retrieval system 420. The RAG-based information retrieval system 420 receives the delegated user query 415 as an input and performs one or more information retrieval operations. The response from the RAG-based information retrieval system 420 may be in the form of ranked results in some embodiments, and the top N results (e.g., the highest-ranking result) may be taken and applied to the language model 410 as one or more prompts (e.g., based at least in part on a prompt size limit).

The RAG-based information retrieval system 420 generates one or more augmented queries 425 based on context-specific knowledge, where the context-specific knowledge may be obtained using the delegated user query 415. RAG is a technique for enhancing the accuracy and/or reliability of generative AI models, such as the language model 410, with information obtained from external sources. The one or more augmented queries 425 ground the language model 410 in some embodiments using one or more external sources of knowledge that supplement the internal representation of information by the language model 410. The RAG-based information retrieval system 420 may be implemented, at least in part, in some embodiments, using the Pryon answer engine, commercially available from Pryon Inc. and/or the information retrieval functionality of the Milvus open-source vector database system.

The one or more augmented queries 425 are applied to the language model 410 that generates a chat assistant response 430 (e.g., relevant information and responses based on a conversational dialogue). The language model 410 may combine the retrieved words in the one or more augmented queries 425 with its own response to the user query 405 into a final chat assistant response 430. The chat assistant response 430 may be communicated to the user, as discussed herein. The chat assistant response 430 may comprise relevant information and responses based on a conversational dialogue.

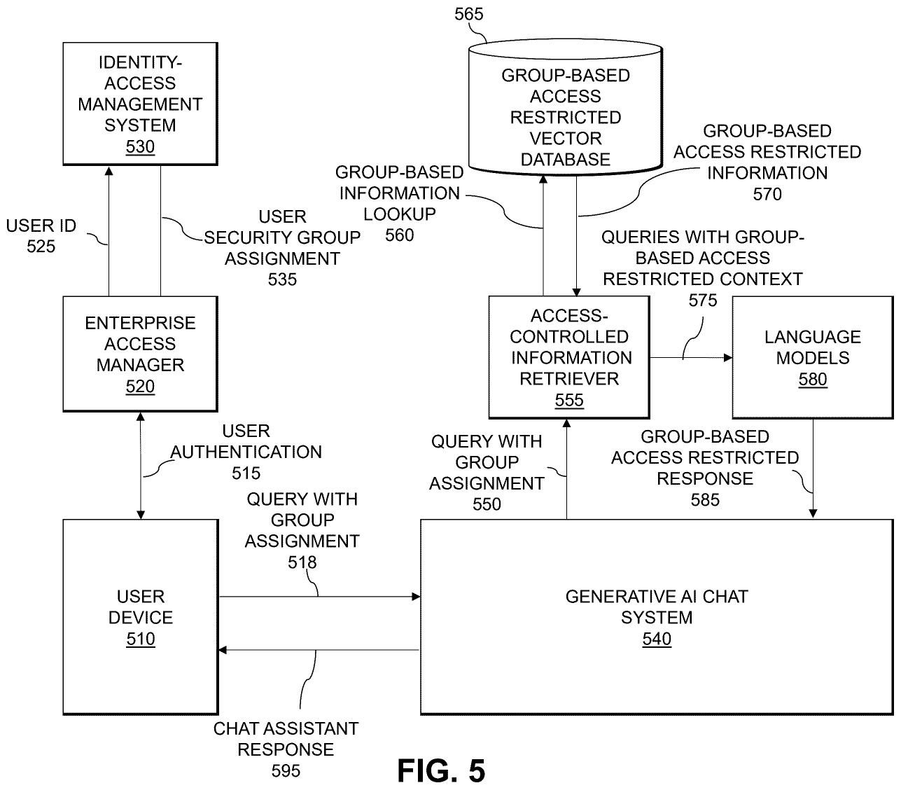

FIG. 5 illustrates a processing of a conversational dialog between a user and a chat assistant using identity-based context generation for language models using security group assignments in accordance with an illustrative embodiment. In the example of FIG. 5, a user of a user device 510 may interact with a chat assistant, for example, to provide a user input (e.g., a user query that asks the chat assistant a question). The user input triggers a user authentication 515 of the user by an enterprise access manager 520. For example, the user authentication 515 may be part of a single-sign on (SSO) activity that returns user information and a security group identifier. The enterprise access manager 520 provides a user ID (identifier) 525 of the user to an identity-access management system 530. The identity-access management system 530 evaluates the user ID 525, for example, using one or more enterprise databases (not shown in FIG. 5) to obtain a user security group assignment 535, which identifies a security group, of multiple security groups, that the user is assigned to. For example, the identity-access management system 530 may perform an identity-based authentication of the user and determine the security group of the user that controls the information that the user is authorized to access. The identity-access management system 530 may employ role-based access control techniques and/or attribute-based access control techniques. The security groups may comprise, for example, active directory security groups, as would be apparent to a person of ordinary skill in the art.

The initial query provided by the user is then redirected to a generative AI chat system 540 as a query with the group assignment 518 of the user. The generative AI chat system 540 processes the query with the group assignment 518; manages a flow and session state of each conversation; understands user queries and generates appropriate responses based on information retrieval techniques and language model responses, as discussed hereinafter. The stored session state of each conversation allows the generative AI chat system 540 to remember previous interactions and other data associated with specific sessions. The stored session state (e.g., previous interactions and other data associated with specific sessions) may be maintained, for example, using Prisma or another object relational mapping (ORM) tool for storage in a vector database.

In the example of FIG. 5, the generative AI chat system 540 provides the query with the group assignment 550 to an access-controlled information retriever 555 (such as a RAG-based information retrieval system) to benefit the conversational flow. The access-controlled information retriever 555 receives the query with the group assignment 550 as an input and performs one or more information retrieval searches. For example, the access-controlled information retriever 555 may perform a group-based information lookup 560 in a group-based access restricted vector database 565, which returns group-based access restricted information 570 to the access-controlled information retriever 555.

In one or more embodiments, embedded data sources are associated with one or more security groups and members of the one or more security groups can access the information stored in such embedded data sources. The group-based access restricted vector database 565 may use metadata tags that identify one or more authorized security groups for each embedded data source, whereby the group-based access restricted vector database 565 may filter the stored information based on an indicated security group of a given user, such that the provided group-based access restricted information 570 is limited to information that the user is authorized to access. In another implementation, different group-based access restricted vector databases 565 may be instantiated for particular security groups selected by the access-controlled information retriever 555 and the provided group-based access restricted information 570 is limited to information that the user is authorized to access.

In some embodiments, the group-based access restricted information 570 comprises search results from one or more embedded data sources in the group-based access restricted vector database 565 that are accessible to the security group of the user. The access-controlled information retriever 555 may provide ranked results in some embodiments, and the top N results (e.g., the highest-ranking result) may be applied to one or more language models 580 as one or more queries with group-based access restricted context 575 (e.g., based at least in part on a prompt size or token limit).

In this manner, the disclosed techniques for identity-based context generation for language models using security group assignments generate an intent associated with a user query which ensures that an answer to a user query from a given user is limited to information that the security group of the given user may access. An intent layer can automatically route user prompts or user questions to an appropriate chat assistant. In addition, the intent layer can offer suggestions and ask for guidance if the intent layer is unsure of the user intent and/or best chat assistant to handle the user request.

The one or more queries with group-based access restricted context 575 ground the one or more language models 580 in some embodiments using one or more external sources of knowledge that supplement the internal representation of information by the language models 580. As noted above, the access-controlled information retriever 555 may be implemented, at least in part, in some embodiments, using the Pryon answer engine, commercially available from Pryon Inc. and/or the information retrieval functionality of the Milvus open-source vector database system.

The one or more queries with group-based access restricted context 575 are applied to the language model 580 that generates a group-based access restricted response 585 (e.g., relevant information and responses based on a conversational dialogue that the security group of the user is authorized to access). The language models 580 may combine the results from the access-controlled information retriever 555 (comprising the one or more queries with group-based access restricted context 575 that the user is authorized to access) with their own responses to the user query into a group-based access restricted response 585. The group-based access restricted response 585 may be communicated to the user, for example, via the generative AI chat system 540, as discussed herein. The group-based access restricted response 585 may comprise relevant access restricted information, and responses based on a conversational dialogue. The generative AI chat system 540 may provide a chat assistant response 595 to the user device 510 for presentation to the user, for example, using a user interface.

FIG. 6 is a sample table 600 illustrating exemplary information maintained for representative embedded data sources in accordance with an illustrative environment. In the example of FIG. 6, for each embedded data source of a given enterprise, for example, the table of FIG. 6 indicates a corresponding embedded data source identifier, a list of one or more security groups that can access the respective embedded data source and a contributor (e.g., a particular enterprise team) of the respective embedded data source.

In some embodiments, a given user may contribute (e.g., provide) an embedded data source for use by a team and/or security group comprising the given user. For example, the given user can contribute an embedded data source and provide a connection string (e.g., a network address) to a vector database collection. If a given embedded data source does not have a list of security groups that can access the given embedded data source, then the given embedded data source may be considered to have an internal public accessibility (see, e.g., data source 267 in FIG. 6).

As noted above, when a given user is authentication using SSO techniques, for example, the security group of the given user may be identified, which can be passed from the frontend of the generative AI chat system 540, for example, to a backend of the generative AI chat system 540. The generative AI chat system 540 can provide an API that accepts a “security group” field that allows a verification of whether the security group associated with a given user query has access to particular embedded data sources.

FIG. 7 is a sample table 700 illustrating exemplary information maintained for representative chat assistants that are shared in accordance with an illustrative environment. As noted above, some embodiments of the disclosure provide a library of available chat assistants that can be selected to answer one or more queries of the user. The library of available chat assistants may be generated by users sharing one or more generated chat assistants with other users through the library of available chat assistants. Such a chat assistant library (sometimes referred to as a chat assistant store) allows users to bypass a recommended or default chat assistant and go directly to the library of selectable chat assistants to make an informed selection.

In various embodiments, users can share or publish chat assistants as either public (internal for all users of the generative AI chat platform 105, for example, or as private for a restricted group (e.g., one or more security groups). RBAC permissions can be managed at the chat assistant level, for example, without the complexity of integrating and synchronizing data permissions across an enterprise data landscape.

In the example of FIG. 7, for each available chat assistant of a given enterprise, for the table of FIG. 7 indicates a corresponding chat assistant identifier, one or more language model identifiers associated with the respective chat assistant, a system prompt identifier associated with the respective chat assistant, one or more document collection identifiers associated with the respective chat assistant, a publisher of the respective chat assistant and one or more access restrictions associated with the respective chat assistant (e.g., restricted group lists, such as security groups). If a given available chat assistant does not have a list of security groups that can access the given available chat assistant, then the given available chat assistant is considered to have an internal public accessibility (see, e.g., chat assistant ALA and/or chat assistant X45 in the table of FIG. 7).

For example, a representative system prompt may define a behavior of one or more chat assistants, as follows: “You are an enterprise AI-powered chat assistant developed and maintained by team X of enterprise Y. Follow the instructions from a user carefully. Respond using markdown and format code blocks with proper language syntax highlighting. Given the following extracted parts of a long document for context and a question, create a final answer without any additional questions. When creating your final answer, try to rephrase the question to use it as part of your answer. If you do not know the answer, just say that you do not know the answer. Do not try to make up an answer. Try to respond in natural language. Treat a user input as a question, even if the user input does not look like a question. Do not include useful links in the response.”

In this manner, users can build on the work of others by duplicating and modifying existing chat assistants and sharing their work with others. In various embodiments, the available chat assistants in the table of FIG. 7, for example, can be selected to represent a collection of chat assistants with the ability to communicate with each other (e.g., collaborate) to generate a best response to a user query.

In one or more embodiments, the library of available chat assistants can be deployed with no-code and/or low-code, for example. In a no-code deployment, multiple models and embeddings collections may be employed, with advanced settings, and the ability to adjust LLM model parameters, the types of embeddings models, similarity search distance metrics, system prompts, prompt templates, assistants, and other tools, for example. In a low-code deployment, custom conversational assistants may be generated with low-code using, for example, Python, LangChain, available LLM prompt templates and/or LLM tool/function calls.

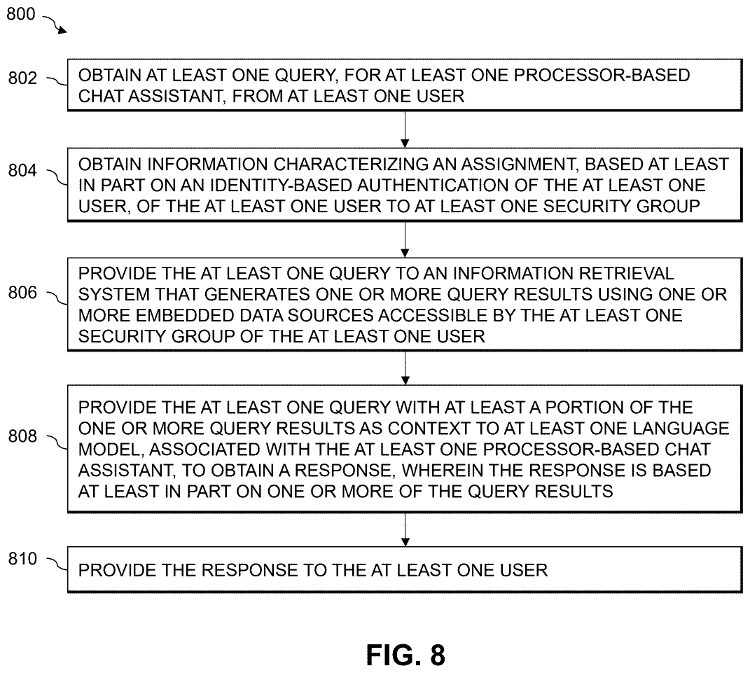

FIG. 8 is a flow diagram illustrating an exemplary implementation of a process 800 for identity-based context generation for language models using security group assignments in accordance with an illustrative embodiment. In the example of FIG. 8, at least one query is obtained in step 802, for at least one processor-based chat assistant, from at least one user. Information is obtained in step 804 characterizing an assignment of the at least one user to at least one security group. The assignment in step 804 may be based at least in part on an identity-based authentication of the at least one user.

The at least one query is provided in step 806 to an information retrieval system that generates one or more query results using one or more embedded data sources accessible by the at least one security group of the at least one user. The at least one query is provided in step 808 with at least a portion of the one or more query results as context to at least one language model, associated with the at least one processor-based chat assistant, to obtain a response, wherein the response is based at least in part on one or more of the query results. The response is provided in step 810 to the at least one user.

In at least one embodiment, at least one of the one or more embedded data sources that are accessible by the at least one security group of the at least one user is provided by the at least one user. At least one embedded data source provided by the at least one user may be accessible by one or more additional users in a same security group as the at least one user.

In some embodiments, the one or more query results are generated using a similarity search between the at least one query and data in the one or more embedded data sources accessible by the at least one security group of the at least one user. The providing the at least one query with the portion of the one or more query results to the at least one language model may further comprise providing information characterizing at least a portion of one or more historical conversations of the at least one user obtained from a vector database.

In one or more embodiments, the at least one processor-based chat assistant is selected from a plurality of available processor-based chat assistants shared by a plurality of users. One or more of the plurality of available processor-based chat assistants may employ security group-based access restrictions. At least two of the plurality of available processor-based chat assistants may employ different system prompts. The plurality of available processor-based chat assistants may be distributed using a deployment chart, such as a Helm deployment chart.

In an exemplary embodiment, one or more of the at least one processor-based chat assistant and the at least one language model is selected by the at least one user. One or more parameters of the at least one language model may be specified by the at least one user.

The particular processing operations and other network functionality described in conjunction with FIGS. 2 through 5 and 8 for example, are presented by way of illustrative example only, and should not be construed as limiting the scope of the disclosure in any way. Alternative embodiments can use other types of processing operations for identity-based context generation for language models using security group assignments. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for identity-based context generation for language models using security group assignments. The foregoing applications and associated embodiments should be considered as illustrative only, and numerous other embodiments can be configured using the techniques disclosed herein, in a wide variety of different applications.

It should also be understood that the disclosed techniques for identity-based context generation for language models using security group assignments, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for identity-based context generation for language models using security group assignments may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a PaaS, IaaS, STaaS and/or FaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based generative AI chat engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based generative AI chat platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

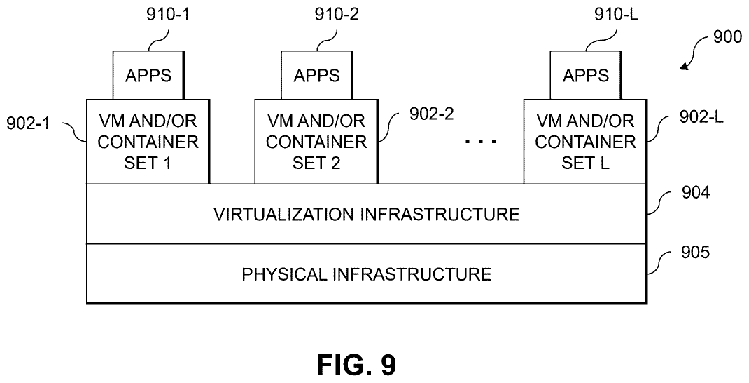

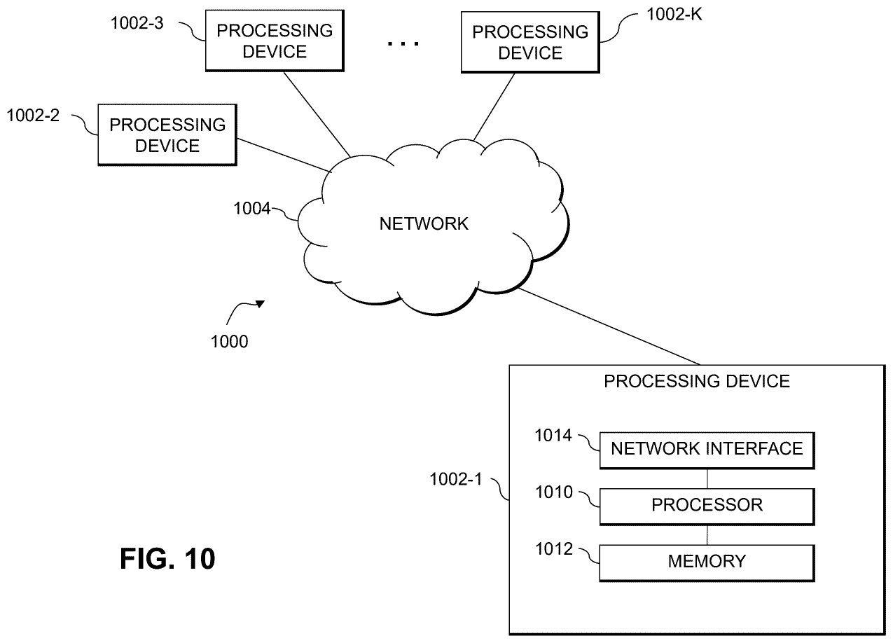

Illustrative embodiments of processing platforms will now be described in greater detail with reference to FIGS. 9 and 10. These platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. Such implementations can provide chat assistant adaptation functionality of the type described above for one or more processes running on a given one of the VMs. For example, each of the VMs can implement generative AI chat control logic and associated functionality for identity-based context generation for language models using security group assignments, for one or more processes running on that particular VM.

An example of a hypervisor platform that may be used to implement a hypervisor within the virtualization infrastructure 904 is a compute virtualization platform which may have an associated virtual infrastructure management system such as server management software. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system. Such implementations can provide chat assistant adaptation functionality of the type described above for one or more processes running on different ones of the containers. For example, a container host device supporting multiple containers of one or more container sets can implement one or more instances of generative AI chat control logic and associated functionality for identity-based context generation for language models using security group assignments.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises at least a portion of the given system and includes a plurality of processing devices, denoted 1002-1, 1002-2, 1002-3, . . . 1002-K, which communicate with one another over a network 1004. The network 1004 may comprise any type of network, such as a WAN, a LAN, a satellite network, a telephone or cable network, a cellular network, a wireless network such as WiFi or WiMAX, or various portions or combinations of these and other types of networks.

The processing device 1002-1 in the processing platform 1000 comprises a processor 1010 coupled to a memory 1012. The processor 1010 may comprise a microprocessor, a microcontroller, an ASIC, an FPGA or other type of processing circuitry, as well as portions or combinations of such circuitry elements, and the memory 1012, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 9 or 10, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one query, for at least one processor-based chat assistant, from at least one user;
obtaining information characterizing an assignment of the at least one user to at least one security group, wherein the assignment is based at least in part on an identity-based authentication of the at least one user;
providing the at least one query to an information retrieval system that generates one or more query results using one or more embedded data sources accessible by the at least one security group of the at least one user;
providing the at least one query with at least a portion of the one or more query results as context to at least one language model, associated with the at least one processor-based chat assistant, to obtain a response, wherein the response is based at least in part on one or more of the query results; and
providing the response to the at least one user;
wherein the method is performed by at least one processing device comprising a processor coupled to a memory.

2. The method of claim 1, wherein at least one of the one or more embedded data sources that are accessible by the at least one security group of the at least one user is provided by the at least one user.

3. The method of claim 2, wherein the at least one embedded data source provided by the at least one user is accessible by one or more additional users in a same security group as the at least one user.

4. The method of claim 1, wherein the one or more query results are generated using a similarity search between the at least one query and data in the one or more embedded data sources accessible by the at least one security group of the at least one user.

5. The method of claim 1, wherein the providing the at least one query with the portion of the one or more query results to the at least one language model further comprises providing information characterizing at least a portion of one or more historical conversations of the at least one user obtained from a vector database.

6. The method of claim 1, wherein the at least one processor-based chat assistant is selected from a plurality of available processor-based chat assistants shared by a plurality of users.

7. The method of claim 6, wherein one or more of the plurality of available processor-based chat assistants employ security group-based access restrictions.

8. The method of claim 6, wherein at least two of the plurality of available processor-based chat assistants employ different system prompts.

9. The method of claim 6, wherein the plurality of available processor-based chat assistants is distributed using a deployment chart.

10. The method of claim 1, wherein one or more of the at least one processor-based chat assistant and the at least one language model is selected by the at least one user.

11. The method of claim 1, wherein one or more parameters of the at least one language model are specified by the at least one user.

12. An apparatus comprising:
at least one processing device comprising a processor coupled to a memory;
the at least one processing device being configured to implement the following steps:
obtaining at least one query, for at least one processor-based chat assistant, from at least one user;
obtaining information characterizing an assignment of the at least one user to at least one security group, wherein the assignment is based at least in part on an identity-based authentication of the at least one user;
providing the at least one query to an information retrieval system that generates one or more query results using one or more embedded data sources accessible by the at least one security group of the at least one user;
providing the at least one query with at least a portion of the one or more query results as context to at least one language model, associated with the at least one processor-based chat assistant, to obtain a response, wherein the response is based at least in part on one or more of the query results; and
providing the response to the at least one user.

13. The apparatus of claim 12, wherein at least one of the one or more embedded data sources that are accessible by the at least one security group of the at least one user is provided by the at least one user.

14. The apparatus of claim 12, wherein the at least one processor-based chat assistant is selected from a plurality of available processor-based chat assistants shared by a plurality of users.

15. The apparatus of claim 14, wherein one or more of the plurality of available processor-based chat assistants employ security group-based access restrictions.

16. The apparatus of claim 12, wherein one or more of the at least one processor-based chat assistant and the at least one language model is selected by the at least one user.

17. A non-transitory processor-readable storage medium having stored therein program code of one or more software programs, wherein the program code when executed by at least one processing device causes the at least one processing device to perform the following steps:
obtaining at least one query, for at least one processor-based chat assistant, from at least one user;
obtaining information characterizing an assignment of the at least one user to at least one security group, wherein the assignment is based at least in part on an identity-based authentication of the at least one user;
providing the at least one query to an information retrieval system that generates one or more query results using one or more embedded data sources accessible by the at least one security group of the at least one user;
providing the at least one query with at least a portion of the one or more query results as context to at least one language model, associated with the at least one processor-based chat assistant, to obtain a response, wherein the response is based at least in part on one or more of the query results; and
providing the response to the at least one user.

18. The non-transitory processor-readable storage medium of claim 17, wherein at least one of the one or more embedded data sources that are accessible by the at least one security group of the at least one user is provided by the at least one user.

19. The non-transitory processor-readable storage medium of claim 17, wherein the at least one processor-based chat assistant is selected from a plurality of available processor-based chat assistants shared by a plurality of users.

20. The non-transitory processor-readable storage medium of claim 17, wherein one or more of the at least one processor-based chat assistant and the at least one language model is selected by the at least one user.
